(19) United States
(12) Patent Application Publication
(10) Pub. No.: US 2010/0077246 A1
(43) Pub. Date: Mar. 25, 2010

(54) Microprocessor system having a plurality of microprocessors which are connected to one another by signaling technology

(76) Inventors: Steffen Dittrich, Erlangen (DE); Thomas Fleischmann, Rothenbach (DE); Thorsten Stempel, Kirchseeon (DE)

Correspondence Address: HARNESS, DICKEY & PIERCE, P.L.C., P.O.BOX 8910, RESTON, VA, 20195, US

(21) Appl. No.: 12/585,581

(22) Filed: Sep. 18, 2009

(30) Foreign Application Priority Data
Sep. 24, 2008 (DE) 10 2008 049 161.6

(51) Int. Cl. G06F 1/12

(52) U.S. Cl. 713/375

(57) ABSTRACT

A microprocessor system includes a plurality of microprocessors which are connected to one another by signaling technology. In order to temporally synchronize the microprocessors in a relatively simple manner, it is proposed in at least one embodiment that provision be made of a central clock generator which outputs a clock signal in the form of temporally successive pulses to all microprocessors in a parallel manner, that provision be made of a master which can switch the output of the clock signal on and off, that all microprocessors sum the clock signal from the central clock generator in the form of a counter reading in each case, that the master be able to reset the counter readings of all microprocessors. In at least one embodiment, in order to synchronize all microprocessors, the master first of all interrupt the output of the clock signal, then set all counter readings to a defined value, and then cancel the interruption of the output of the clock signal again.

### PRIORITY STATEMENT

The present application hereby claims priority under 35 U.S.C. §119 on German patent application number DE 10 2008 049 161.6 filed Sep. 24, 2008, the entire contents of which are hereby incorporated herein by reference.

### FIELD

At least one embodiment of the invention generally relates to a microprocessor system having a plurality of microprocessors which are connected to one another by signaling technology.

### BACKGROUND

Systems having a plurality of microprocessors which are connected to one another by way of a bus are known as so-called distributed multiprocessor systems. In this case, it is often necessary for all microprocessors to be synchronized with a single time source, which may be effected by transmitting the current time information to the individual processors. However, a time delay on the transmission path and caused by the processing of the time information must not be produced during transmission. For this reason, use is often made of a central time source which has as many parallel outputs as there are microprocessors. However, it must be ensured in this case that all microprocessors either fetch or receive the time information at the same time if time shifts which have occurred are not intended to or cannot be subsequently compensated for.

### SUMMARY

At least one embodiment of the invention specifies a microprocessor system in which its microprocessors are temporally synchronized in a relatively simple manner.

At least one embodiment provides for provision to be made of a central clock generator which outputs a clock signal in the form of temporally successive pulses to all microprocessors in a parallel manner, for provision to be made of a master which can switch the output of the clock signal on and off, for all microprocessors to sum the clock signal from the central clock generator in the form of a counter reading in each case, for the master to be able to reset the counter readings of all microprocessors, and, in order to synchronize all microprocessors, for the master to first of all interrupt the output of the clock signal, to then set all counter readings to a defined value, and to then cancel the interruption of the output of the clock signal again. The central clock generator thus provides a (highly accurate) clock signal in the form of temporally successive pulses, which clock signal is distributed to all active microprocessors in a star-like manner. The clock signal pulses are then counted in separate counting devices (in particular counting devices which function in the same manner), the counter reading respectively corresponding to the time. After the clock signal has been switched on, the summing operation starts synchronously again. This makes it possible to correct differences in the counter readings in a simple manner and to operate all counters in a synchronous manner.

One simple embodiment provides for one of the microprocessors themselves to act as a master, that is to say to form its own counter reading from the clock signal and to set it to a defined value for the purpose of synchronization.

In order to synchronize the microprocessors with an absolute time, it is proposed that the clock signal be able to be synchronized with the absolute time from an external time source.

It is expedient if the central clock generator likewise has a counter which is operated by an internal oscillator.

It is simple, in terms of circuitry, if a timing clock is derived from the absolute time, and the clock signal is synchronized with the timing clock of the absolute time by way of a counter to which the timing clock of the absolute time can be additionally applied for the purpose of synchronization.

In order to be able to provide events with a time stamp containing the absolute time, it is proposed that the master have access to the absolute time which is available to the central clock generator via the external time source.

It is technically simple if, when the output of the clock signal is interrupted, the counter in the central clock generator is no longer clocked either and the master can also reset the counter reading of this counter after the output of the clock signal has been interrupted.

### BRIEF DESCRIPTION OF THE DRAWINGS

The invention is described in more detail below using an example embodiment. In the drawings:

FIG. 1 shows a microprocessor system having a master for temporally synchronizing the microprocessors, and

FIG. 2 shows a microprocessor system which can be synchronized with an absolute time.

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

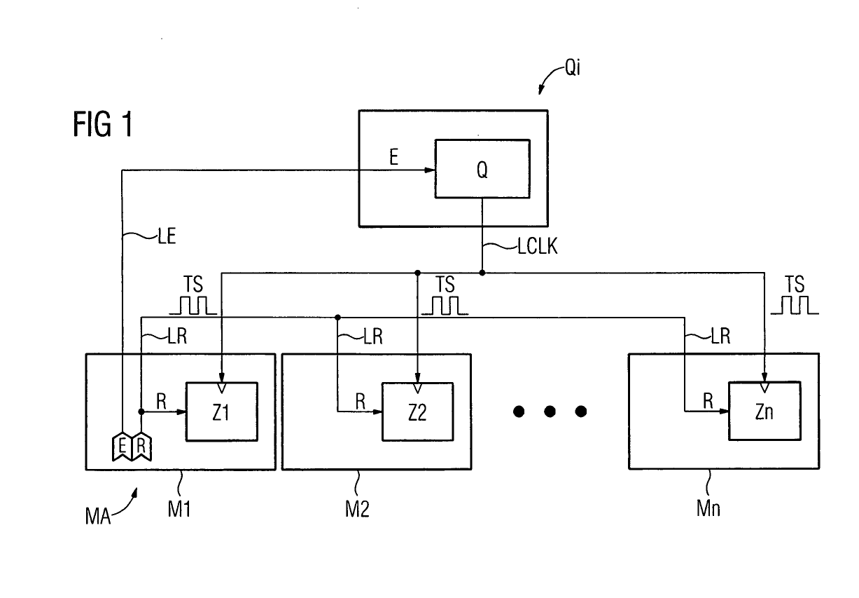

FIG. 1 shows a microprocessor system having microprocessors M1, M2, . . . , Mn which are connected to one another by signaling technology.

In the system, a (highly accurate) clock signal TS in the form of temporally successive (rectangular) pulses from a central clock generator Q in an internal time source Qi is distributed to all (active) microprocessors M1, M2, . . . , Mn in a star-like manner via the signal line Lclk. Each microprocessor M1, M2, . . . , Mn has an internal separate counter Z1, Z2, . . . , Zn which counts the pulses of the clock signal TS and in the process forms a new counter reading in each case (each new pulse increases the counter reading by a counter, that is to say by 1). The counters Z1, Z2, . . . , Zn are identical, that is to say they all function in the same manner. The counter reading of the counters Z1, Z2, . . . , Zn corresponds to the time for the respective associated microprocessor M1, M2, . . . , Mn. The counter reading and time thus correspond to one another. A time stamp or a time marking of an event then corresponds to the counter reading associated with this event.

One of the microprocessors M1, M2, . . . , Mn (the microprocessor M1 in this case) operates as a master MA, this function of the master MA naturally also being able to be implemented using a separate unit. The master MA is connected to the central clock generator Q by means of a control line LE which can be used by the master MA to transmit an enable signal E to the clock generator Q, which enable signal interrupts the output of the clock signal TS or cancels the interruption again.

The microprocessor M1 and thus the master MA are connected to the other microprocessors M2, . . . , Mn by signaling technology and control technology by means of (control) lines LR. The master MA can use a reset signal R to reset all counters Z1, Z2, . . . , Zn (that is to say including its own counter Z1) to a predefined value (the counter reading 0 in this case). It is thus possible, during a reset, to set all counters Z1, Z2, . . . , Zn to the same defined value and then to continue to count up (or down). This (re)setting of the counters Z1, Z2, . . . , Zn may be effected in temporal succession but also at the same time. After all of the counters Z1, Z2, . . . , Zn have been reset (to the counter reading 0 in this case), the master MA can cancel the interruption of the output of the clock signal TS again. This means that all counters Z1, Z2, . . . , Zn start synchronously when the clock signal TS is switched on again by the master MA, that is to say they are temporally synchronized from then on. This may be repeated if necessary, for example after predefined intervals of time or if the counter readings of the counters Z1, Z2, . . . , Zn differ by more than a predefined value.

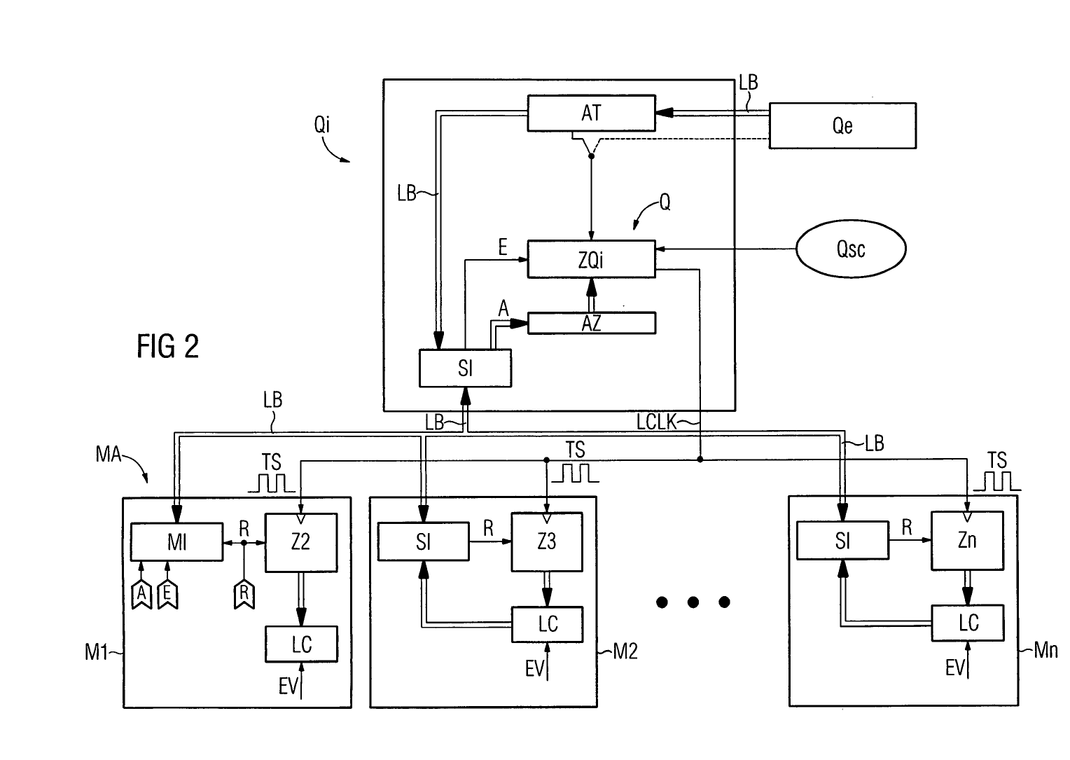

FIG. 2 shows a microprocessor system which is extended in comparison with FIG. 1 and has the microprocessors M1, . . . , Mn which are connected to one another by signaling technology by means of bus lines LB of a bus in this case. The internal time source Qi which outputs the clock signal TS in the form of temporally successive (rectangular) pulses via signal lines Lclk and distributes it to all microprocessors M1, . . . , Mn in a star-like manner is in turn connected to the bus. Each microprocessor M1, . . . , Mn again has a separate internal counter Z1, Z2, . . . , Zn which respectively counts the pulses of the clock signal TS. The microprocessor M1 again operates as a master MA and is connected to the bus via a master interface M1, while all other microprocessors M2, . . . , Mn and the internal source Qi are connected via a slave interface SI, that is to say operate in the slave mode.

In contrast to the microprocessor system according to FIG. 1, an external source Qe provides an absolute time AT and is likewise connected to the internal time source Qi via a bus line LB of the (system) bus of the microprocessor system. The master MA has direct access to this absolute time AT via the bus and the slave interface SI of the internal source Qi.

Furthermore, the internal source Qi now contains a counter ZQi to which an oscillator Osc is connected, the clock of the oscillator being counted by the counter ZQi and the latter outputting a clock signal TS, which is correlated with said clock, in the form of pulses via the line Lclk. The counter ZQi additionally has an input for a timing clock derived from the absolute time AT from the external time source Qe, the counter ZQi being constructed in such a manner that it is itself synchronized with the absolute time AT using this timing clock. In other words: the counter reading of the counter ZQi respectively corresponds to the absolute time AT or respectively reflects the absolute time AT. The oscillator Osc need not be a highly accurate oscillator since the clock signal TS is respectively synchronized (corrected) with the absolute time AT from the external source Qe in this case.

In order to temporally synchronize all microprocessors M1, M2, . . . , Mn, the master MA (that is to say the microprocessor M1 acting as the master MA) outputs an enable signal E which stops the counter ZQi and thus interrupts the output of the clock signal TS. The master MA then uses an adjust signal to load a starting counter reading AZ into the counter ZQi, that is to say the value 0. The master MA also passes a reset signal R to the counters Z1, Z2, . . . , Zn of the remaining microprocessors M2, . . . , Mn via the slave interfaces SI of the latter, as a result of which said counters are reset, to be precise likewise to the counter reading 0 in this case. An enable signal E is then passed to the counter ZQi via the slave interface SI of the internal time source Qi by means of a line LE in order to restart the internal source Qe, that is to say switch on the clock signal TS with the pulses. All counters Z1, Z2, . . . , Zn, including the counter Z1 in the master MA, thus also start synchronously.

In the case of an event EV, a special counter LC (latched counter) adopts the counter reading of the associated microprocessor M2, . . . , Mn as the time for the occurrence of this event EV and retains it until the master MA retrieves this counter reading via the slave interface SI and the bus.

Since the master MA has access both to the absolute time AT and to its own counter Z1 which, like all other counters Z1, Z2, . . . , Zn, sums the pulses, it can assign the absolute time AT to all counter readings of these counters Z1, Z2, . . . , Zn and thus also to the counter reading of the event EV. The microprocessor system can be extended (scaled) in any desired manner since only the clock from the clock generator Q and the reset signal R (the “reset mechanism”) have to be distributed.

It goes without saying that it is also possible for the master MA to adjust and compensate for differences from the absolute time AT.

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combineable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program, computer readable medium and computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a computer readable medium and is adapted to perform any one of the aforementioned methods when run on a computer device (a device including a processor). Thus, the storage medium or computer readable medium, is adapted to store information and is adapted to interact with a data processing facility or computer device to execute the program of any of the above mentioned embodiments and/or to perform the method of any of the above mentioned embodiments.

The computer readable medium or storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A microprocessor system, comprising:
a plurality of microprocessors connected to one another by signaling technology;
a central clock generator to output a clock signal in the form of temporally successive pulses to all of the plurality of microprocessors in a parallel manner;
a master, to switch the output of the clock signal on and off, wherein all of the plurality of microprocessors each respectively sum the clock signal from the central clock generator in the form of a counter reading, wherein the master is useable to reset the counter readings of all of the plurality of microprocessors, and wherein, to synchronize all of the plurality of microprocessors, the master is useable to
first interrupt the output of the clock signal,
then set all counter readings to a defined value, and
then cancel the interruption of the output of the clock signal again.

2. The microprocessor system as claimed in claim 1, wherein one of the plurality of microprocessors acts as the master, the master also forming its own counter reading according to the clock signal and respectively setting its counter reading to a defined value for the purpose of synchronization.

3. The microprocessor system as claimed in claim 1, wherein the clock signal is synchronizeable with an absolute time from an external time source.

4. The microprocessor system as claimed in claim 1, wherein the central clock generator has a counter which is clocked by an internal or external oscillator.

5. The microprocessor system as claimed in claim 3, wherein a timing clock is derived from the absolute time, and wherein the clock signal is synchronized with the timing clock of the absolute time by way of a counter to which the timing clock of the absolute time is additionally applied for this purpose.

6. The microprocessor system as claimed in claim 3, wherein the master has access to the absolute time which is available to the central clock generator via the external time source.

7. The microprocessor system as claimed in claim 5, wherein, when the output of the clock signal is interrupted, the counter in the central clock generator is no longer clocked either and the master is also able to reset the counter reading of the counter after the output of the clock signal has been interrupted.

8. The microprocessor system as claimed in claim 2, wherein the clock signal is synchronizeable with an absolute time from an external time source.

9. The microprocessor system as claimed in claim 2, wherein the central clock generator has a counter which is clocked by an internal or external oscillator.

10. The microprocessor system as claimed in claim 3, wherein the central clock generator has a counter which is clocked by an internal or external oscillator.

11. The microprocessor system as claimed in claim 4, wherein a timing clock is derived from the absolute time, and wherein the clock signal is synchronized with the timing clock of the absolute time by way of a counter to which the timing clock of the absolute time is additionally applied for this purpose.

12. The microprocessor system as claimed in claim 8, wherein a timing clock is derived from the absolute time, and wherein the clock signal is synchronized with the timing clock of the absolute time by way of a counter to which the timing clock of the absolute time is additionally applied for this purpose.

13. The microprocessor system as claimed in claim 9, wherein a timing clock is derived from the absolute time, and wherein the clock signal is synchronized with the timing clock of the absolute time by way of a counter to which the timing clock of the absolute time is additionally applied for this purpose.

14. The microprocessor system as claimed in claim 10, wherein a timing clock is derived from the absolute time, and wherein the clock signal is synchronized with the timing clock of the absolute time by way of a counter to which the timing clock of the absolute time is additionally applied for this purpose.

15. The microprocessor system as claimed in claim 4, wherein the master has access to the absolute time which is available to the central clock generator via the external time source.

16. The microprocessor system as claimed in claim 5, wherein the master has access to the absolute time which is available to the central clock generator via the external time source.

17. The microprocessor system as claimed in claim 6, wherein, when the output of the clock signal is interrupted, the counter in the central clock generator is no longer clocked either and the master is also able to reset the counter reading of the counter after the output of the clock signal has been interrupted.
